(19) United States
(12) Patent Application Publication
(10) Pub. No.: US 2023/0236315 A1
(43) Pub. Date: Jul. 27, 2023

(54) IMAGING RADAR SUPER-RESOLUTION FOR STATIONARY OBJECTS

(71) Applicant: QUALCOMM Incorporated, San Diego, CA (US)

(72) Inventors: Amichai SANDEROVICH, Atlit (IL); Eran HOF, Haifa (IL); Evgeny LEVITAN, Haifa (IL); Volodimir SLOBODYANYUK, San Diego, CA (US)

(21) Appl. No.: 18/002,992

(22) PCT Filed: Aug. 10, 2021
(86) PCT No.: PCT/US2021/045369

§ 371 Date: Dec. 22, 2022

(30) Foreign Application Priority Data
Aug. 10, 2020 (IL) 276610

(51) Int. Cl. G01S 13/931; G01S 13/58; G01S 13/42

(52) U.S. Cl. CPC G01S 13/931; G01S 13/428; G01S 13/584

(57) ABSTRACT

Efficient super-resolution of stationary objects (e.g., objects on the roadside or above the road) can be achieved in automotive imaging radar by obtaining sensor information regarding the motion of the radar system (e.g., vehicle speed), performing analog plurality of scans of different elevations, removing motion from the data by applying the inverse of the motion of the radar system, applying a beamspace processing algorithm to achieve super resolution, and outputting a detailed high-resolution radar image of the stationary objects.

### BACKGROUND

Radar sensors can be installed in automobiles for automated or self-driving vehicles. Antenna arrays and beamforming at the transmitter and/or receiver can allow for directional radar scans to be performed, allowing for a radar image to be created of an automobile’s surroundings. There are both analog and digital schemes to allow for beamforming at the transmitter and/or receiver. The native resolution of radar sensors can be inadequate to determine separation of objects at different heights, or elevations. Super-resolution techniques can be used to improve the resolution of radar returns. The improved resolution can be used to help automated vehicles make better decisions.

### BRIEF SUMMARY

Efficient super-resolution of stationary objects (e.g., objects on the roadside or above the road) can be achieved in automotive imaging radar by obtaining sensor information regarding the motion of the radar system (e.g., vehicle speed), performing analog plurality of scans of different elevations, removing motion from the data by applying the inverse of the motion of the radar system, applying a beamspace processing algorithm, or estimation, to achieve super resolution, and outputting a detailed high-resolution radar image of the stationary objects.

An example method of obtaining super resolution in a radar system, according to this disclosure, may comprise performing a scan with the radar system, wherein the scan comprises transmitting, with the radar system, radar signals using a plurality of beams, wherein the plurality of beams is created using analog beamforming, and receiving, with the radar system, reflected radar signal data, from reflections of the radar signals off of one or more objects. The method also may comprise determining a speed of the radar system while the scan was performed. The method also may comprise offsetting the reflected radar signal data by the determined speed of the radar system. The method also may comprise obtaining the super resolution by processing the offset reflected radar signal data using techniques from a beamspace super resolution estimation.

An example radar system for obtaining super resolution, according to this disclosure, may comprise one or more antennas, a transceiver, one or more processors communicatively coupled with the one or more antennas and the transceiver, wherein the one or more processors are configured to perform a scan with the radar system, wherein the scan comprises transmitting, with the transceiver and the one or more antennas, radar signals using a plurality of beams, wherein the plurality of beams is created using analog beamforming, and receiving, with the transceiver and the one or more antennas, reflected radar signal data, from reflections of the radar signals off of one or more objects. The one or more processing units further may be configured to determine a speed of the radar system while the scan was performed. The one or more processing units further may be configured to offset the reflected radar signal data by the determined speed of the radar system. The one or more processing units further may be configured to obtain the super resolution by processing the offset reflected radar signal data using techniques from a beamspace super resolution estimation.

An example apparatus for obtaining super resolution in a radar system, according to this disclosure, may comprise means for performing a scan with the radar system, wherein the means for performing the scan comprises means for transmitting radar signals using a plurality of beams, wherein the plurality of beams is created using analog beamforming, and means for receiving reflected radar signal data, from reflections of the radar signals off of one or more objects. The apparatus further may comprise means for determining a speed of the radar system while the scan was performed. The apparatus further may comprise means for offsetting the reflected radar signal data by the determined speed of the radar system. The apparatus further may comprise means for obtaining the super resolution by processing the offset reflected radar signal data using techniques from a beamspace super resolution estimation.

According to this disclosure, an example non-transitory computer-readable medium stores instructions for obtaining super resolution in a radar system, the instructions comprising code for performing a scan with the radar system, wherein the scan comprises transmitting radar signals using a plurality of beams, wherein the plurality of beams are created using analog beamforming, and receiving reflected radar signal data, from reflections of the radar signals off of one or more objects. The instructions further may comprise code for determining a speed of the radar system while the scan was performed. The instructions further may comprise code for offsetting the reflected radar signal data by the determined speed of the radar system. The instructions further may comprise code for obtaining the super resolution by processing the offset reflected radar signal data using techniques from a beamspace super resolution estimation.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF SUMMARY

The accompanying drawings, which are incorporated into and constitute a part of this specification, illustrate one or more certain examples and, together with the description of the example, serve to explain the principles and implementations of the certain examples.

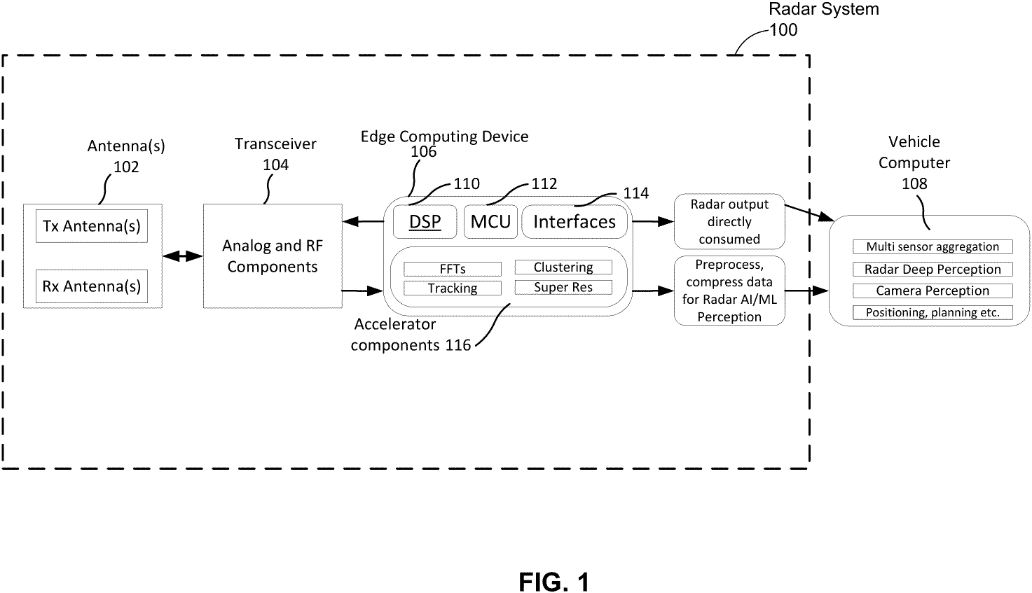

FIG. 1 is a simplified drawing of a radar system that may be used for automotive radar, which can be used to implement the techniques for providing super resolution described herein, according to an embodiment;

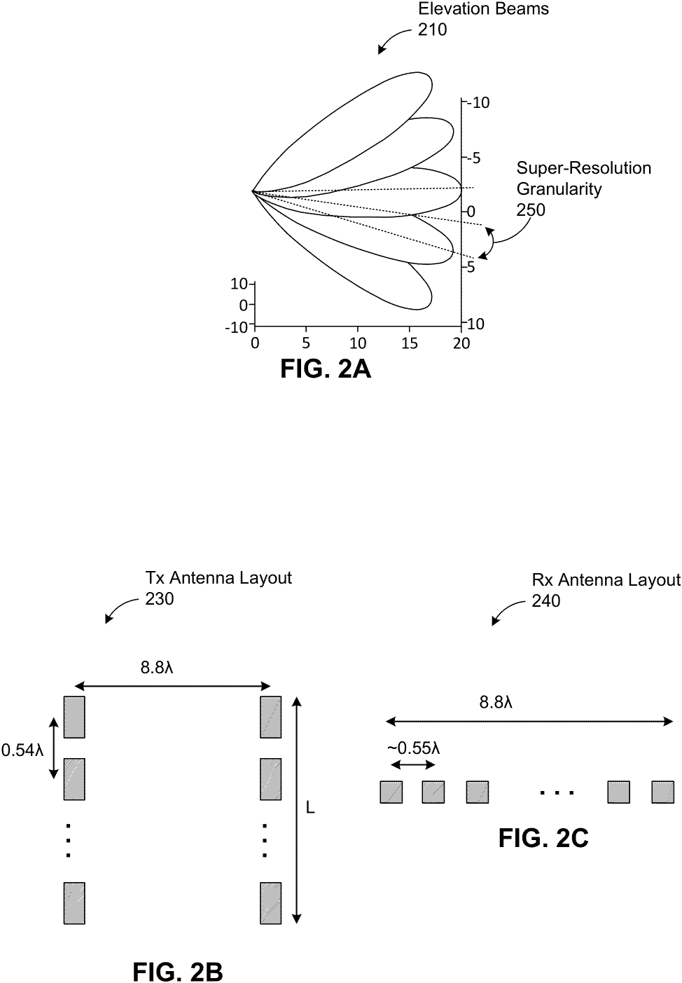

FIGS. 2A-2C are a series of illustrations showing various aspects related to beamforming that can be used and may result in limited resolution in elevation, according to some embodiments;

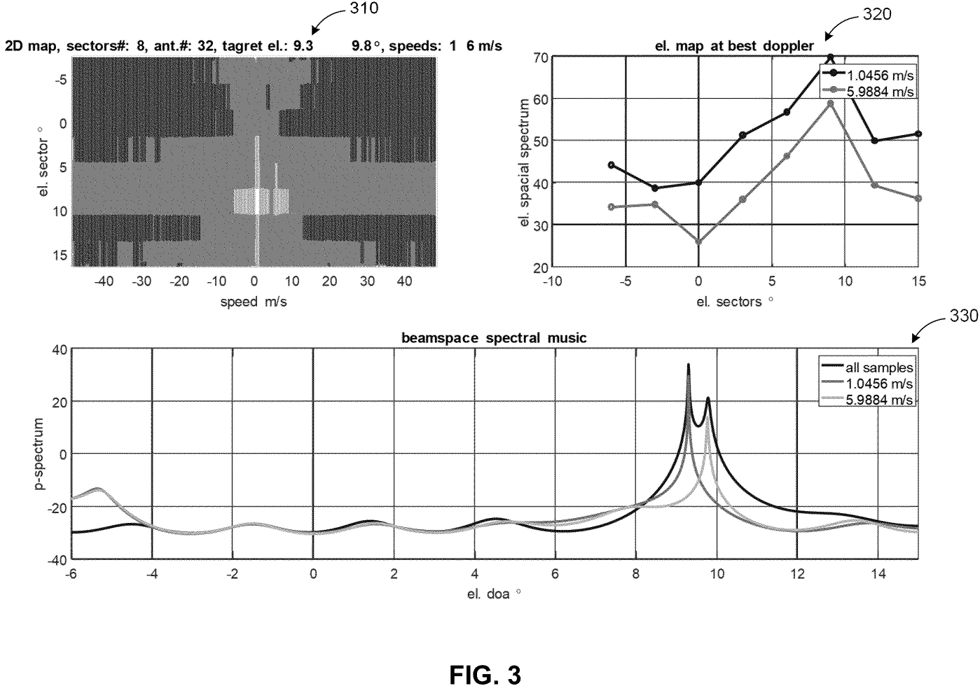

FIG. 3 comprises a series of graphs that illustrate how embodiments can provide elevation super resolution in a first example;

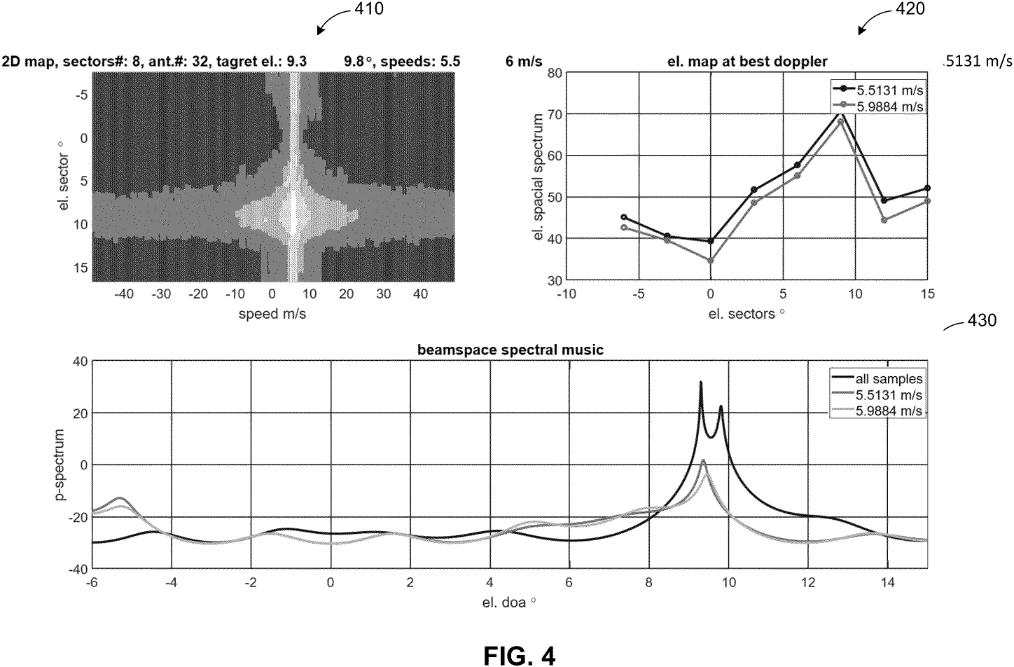

FIG. 4 is a series of graphs similar to those in FIG. 3, which illustrate how embodiments can provide elevation super resolution in a second example;

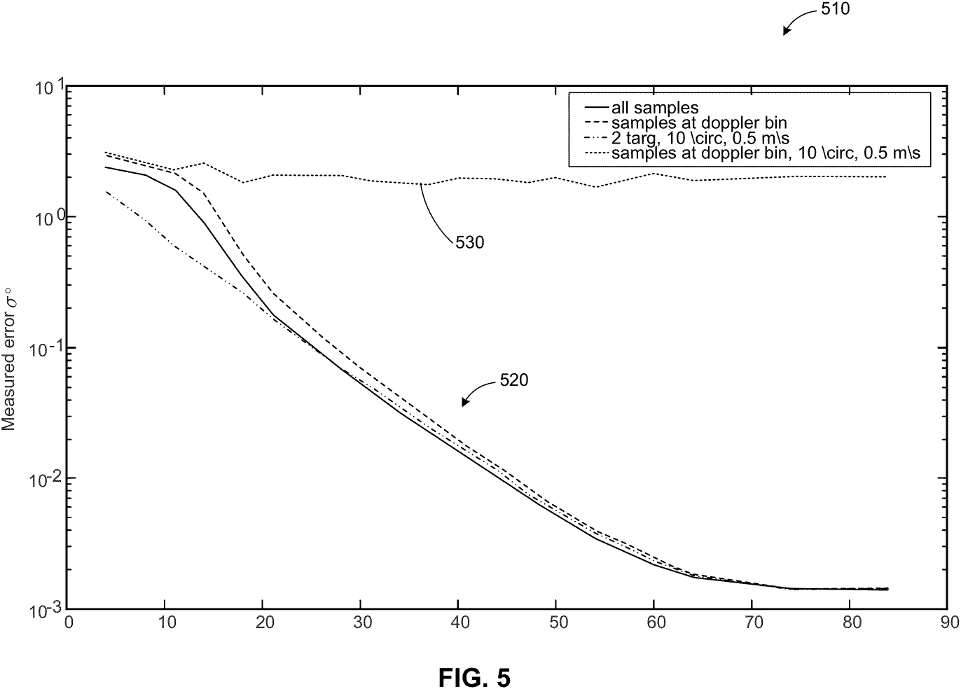

FIG. 5 is a graph showing accuracy as a function of Signal-to Noise Ratio (SNR), illustrating how a knowledge of the speed of the targets can affect accuracy;

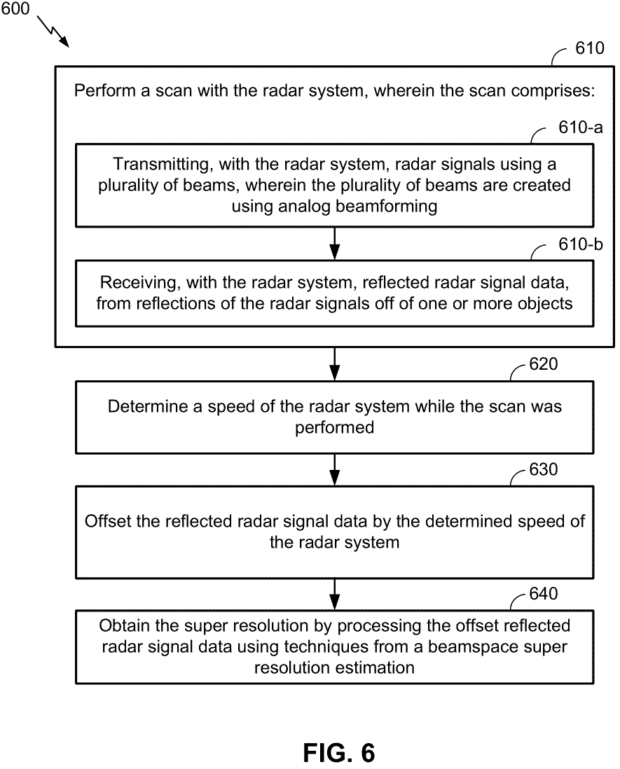

FIG. 6 is a flow diagram of a method of obtaining super resolution in a radar system, according to an embodiment; and

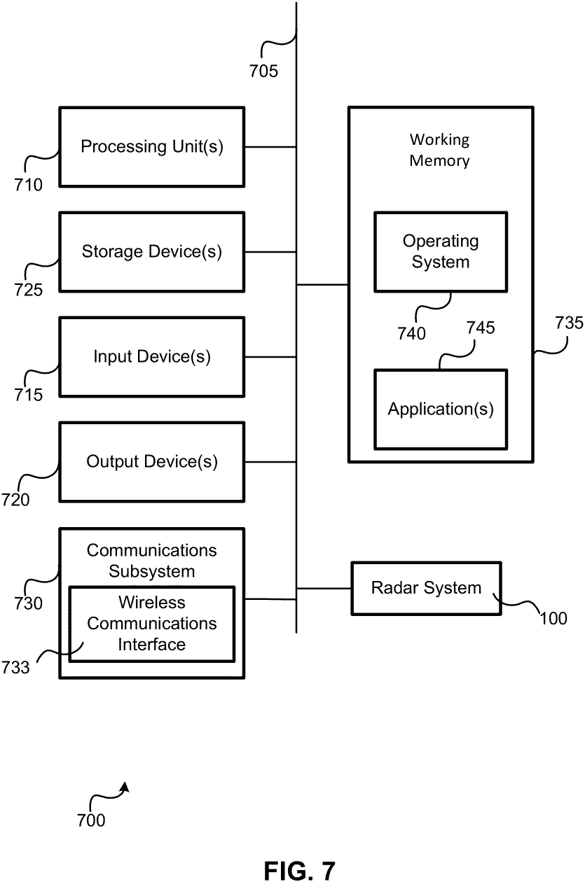

FIG. 7 is a block diagram of an embodiment of a computer system, which may be utilized as described in embodiments herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DESCRIPTION

Several illustrative embodiments will now be described with respect to the accompanying drawings, which form a part hereof. While particular embodiments, in which one or more aspects of the disclosure may be implemented as described below, other embodiments may be used and various modifications may be made without departing from the scope of the disclosure or the spirit of the appended claims.

Radar performance (e.g., resolution, Signal-to Noise Ratio (SNR)) strongly depends on the time spent on each transmission, where more time spent on each transmission generally results in better radar performance. For imaging radar that uses an elevation, the resolution at each elevation may be automotive determined by the total time divided by the total number of elevations. Because of the high frequency of scans (which can be 20 Hz, for example, in automotive applications), this may not allow for an increase of time to conduct the radar scan. And thus, resolution at each elevation may be reduced by a factor of the number of elevations. Furthermore, beamforming can provide a substantial factor in the number of elevations and possible resolution. For example, with analog beamforming at the transmitter antenna array there may be a substantial factor due to the applied circuitry and system that affect the number of possible elevation angles and possible resolution.

Despite this drawback, an elevation scan may be particularly helpful for imaging in automotive applications. Scans can be taken across different elevations, estimates, ranges, and Doppler to provide a 3D map of Channel Impulse Responses (CIRs) of scanned areas, which can provide more information and may be more robust in adverse conditions (e.g., adverse lighting and/or weather conditions) than traditional cameras. Radar scans can therefore provide valuable information that can complement existing automotive systems. For example, a radar scan that provides elevation information can be used by an automobile to correct simultaneous localization and mapping (SLAM) information (e.g., with regard to bridges and buildings), correct object detection (distinguishing, for example, between a bridge or sign and a stop car), identifying unique places that require good separation in the elevation space (e.g., a tunnel or garage entrance), and more.

Spectral processing algorithms such as Multi Signal Classification (MUSIC) Matrix Pencil, or Estimation of Signal Parameters by Rotational Invariance Techniques (ESPRIT) can be used to process various system parameters, such as elevation, azimuth, speed (Doppler), and range. These algorithms can often be performed in beamspace to reduce complexity.

Embodiments herein address these and other issues by obtaining sensor information regarding the motion of the radar system (e.g., vehicle speed), performing analog plurality of scans of different elevations, removing motion from the data by applying the inverse of the motion of the radar system, applying a beamspace processing algorithm to achieve super resolution, and outputting a detailed high-resolution radar image of any stationary objects (e.g., objects on the roadside or above the road).

It can be noted that, although embodiments described herein are directed toward achieving elevation super resolution, alternative embodiments may additionally or alternatively achieve super resolution for azimuth using similar techniques. That is, alternative embodiments may utilize architectures where transmission beamforming (e.g., digital, analog, or hybrid) is carried out for azimuth (in addition or as an alternative to elevation), and the techniques described herein for utilizing a beamspace processing algorithm to achieve super resolution may be carried out for azimuth super resolution (and/or elevation). Further, although embodiments described herein describe automotive applications, some embodiments may be employed in applications other than automotive applications, including any application utilizing imaging radar.

As used herein, the terms “waveform,” “sequence,” and derivatives thereof are used interchangeably to refer to radio frequency (RF) signals generated by a transmitter of the radar system and received by a receiver of the radar system for object detection. A “pulse” and derivatives thereof are generally referred to herein as a complementary pair of sequences. Further, the terms “transmitter,” “Tx,” and derivatives thereof are used to describe components of a radar system used in the creation and/or transmission of RF signals. (As described in further detail below, this can include hardware and/or software components, such as processors, specialized circuitry, and one or more antennas.) Similarly, the terms “receiver,” “Rx,” and derivatives thereof are used to describe components of a radar system used in the receipt and/or processing of RF signals. (Again, this can include hardware and/or software components, such as processors, specialized circuitry, and one or more antennas.)

FIG. 1 is a simplified drawing of a radar system 100 that may be used for automotive radar, which can be used to implement the techniques for providing super resolution described herein below, according to an embodiment. The radar system 100 can be used to detect one or more objects in the vicinity of the vehicle (e.g., in front, behind, or to either side of the vehicle). The radar system 100 may be used, for example, in autonomous vehicles, semi-autonomous vehicles (e.g., vehicles equipped with Advanced Driver-Assistance Systems (ADAS)), and the like. Depending on desired functionality, a vehicle may have one or more radar systems 100.

The radar system 100 can have multiple components including antenna(s) 102, a transceiver 104, an edge computing device 106, and a vehicle computer 108. The edge computing device 106 can include one or more digital signal processors 110, a microcontroller 112, one or more interfaces 114, and one or more accelerator components 116. The various components can be communicatively connected via wired and/or wireless communications. FIG. 1 is a notional drawing and the various components can be configured as a single form-factor device or can be combined as various different devices. As used herein, the term “edge computing device” comprises a device including one or more hardware and/or software components used to perform processing and/or preprocessing of radar signals within the radar system 100 at or near the transceiver 104 to facilitate large data throughput. Thus, in some embodiments, the antenna(s) 102, the transceiver 104, and the edge computing device 106 can be positioned in close proximity for high data throughput. In these embodiments, the vehicle computer 108 may be located in a different area of the vehicle where there can be additional space.

The antenna(s) 102 may be used for both transmitting and receiving the radar signals. In some embodiments, two separate antennas (or antenna arrays, as noted hereafter) may be used: one for transmitting the radar signals, and one for receiving the radar signals. As shown in FIGS. 2 and described in more detail below, the Tx antenna and Rx antenna may comprise antenna arrays, enabling beamforming that perform scans in multiple elevations.

The transceiver 104 is a component capable of both transmitting and receiving radar signals via the antenna(s) 102. To do so, the transceiver 104 may comprise analog and digital radio frequency (RF) components, such as a transmitter chip and/or a receiver chip, amplifiers, filters, etc. Received data from the transceiver 104 can be sent for processing at the edge computing device 106.

Based on a command signal from the edge computing device 106, the transceiver 104 may generate a radar pulse or series of pulses that is transmitted using the antenna(s) 102 (e.g., Tx antenna(s) of FIG. 1). Some embodiments, such as embodiments for radar imaging, analog beamforming may be used to transmit different pulses in different directions (e.g., different azimuth and/or elevation directions). The radar signal(s) may then reflect off one or more objects and be received by the antenna(s) 102 (e.g., Rx antenna(s) of FIG. 1). The received signal(s) may then be sent to the transceiver 104, and pre-processing and processing May be performed on the received signal(s) in the edge computing device 106.

The edge computing device 106 may include one of more accelerator components 116 comprising one or more hardware or software elements (e.g., specialized processing components) that perform processing on the radar signals. According to some embodiments, accelerometer elements 116 may be included on a chip comprising the transceiver 140 and/or may be included as one or more chips in addition to such a chip. The one or more accelerator components 116may include components configured to perform processing providing Fast Fourier Transform (FFT), clustering, tracking, and/or super-resolution of received radar signals. Thus, in according to some embodiments, the techniques for providing super resolution as described herein may be implemented by the edge computing device 106, and such implementations may include the use of accelerator components 116. In various embodiments, accelerator components 116 maybe hardware elements and/or implemented by low-level Digital Signal Processers (DSPs) (e.g., DSP 110) that can perform signal processing.

The DSP 110 in the edge computing device 106 may be implemented in different ways, depending on desired functionality. DSP algorithms may be run on general-purpose computers and digital signal processors 110. DSP algorithms are also implemented on purpose-built hardware such as Application-Specific Integrated Circuits (ASICs). A digital signal processor (DSP) is a specialized microprocessor with its architecture optimized for the operational needs of digital signal processing. The goal of a DSP is usually to measure, filter, or compress continuous real-world analog signals. Most general-purpose microprocessors can also execute digital signal processing algorithms successfully but may not be able to keep up with such processing continuously in real-time. In addition, dedicated DSPs usually have better power efficiency, thus they are more suitable in portable devices such as mobile sensors because of power consumption constraints. DSPs often use special memory architectures that can fetch multiple data or instructions at the same time.

The edge computing device 106 can also include a microcontroller unit (MCU) 112. The MCU 112 may comprise one or more processor cores along with memory and programmable input/output peripherals. Program memory in the form of ferroelectric Random Access Memory (RAM), NOR flash or One Time Programmable (OTP) Read-Only Memory (ROM) is also often included in the MCU 112, as well as a small amount of RAM.

One or more interfaces 114 can enable the edge computing device to communicate data between the transceiver 104 and a vehicle computer 108. The one or more interfaces 114 may comprise wired and/or wireless interfaces enabling the radar system 100 to provide (e.g., among other things) preprocessed and/or processed radar information to the vehicle computer 108. As noted in FIG. 1, one or more preprocessing steps may be performed at the radar system 100 (e.g., compress the data for radar artificial intelligence/machine learning perception, as shown in FIG. 1), and the output of these processes may be communicated to the vehicle computer 108. In the vehicle computer 108, one or more additional processing steps may be performed, including but not limited to multi-sensor aggregation, radar deep perception, camera perception, positioning and planning, etc.

In some embodiments, super-resolution processing can be performed on the radar data. In some cases, beamspace can be used to reduce complexity, in which case the radar data can be mapped to beamspace. As described in more detail below, however, embodiments may apply beamspace techniques to radar data as if it is beamed (already in beamspace) due to the transmission technology (analog beamforming) applied. The processed data can be sent to the vehicle computer 108. In some embodiments, the raw radar data can be sent to the vehicle computer 108, which may conduct super-resolution processing.

FIGS. 2A-2C are a series of illustrations showing various aspects related to beamforming that can be used and may result in limited resolution in elevation, according to some embodiments. FIG. 2A is a graph illustrating example elevation beams 210 that can be used in radar scan performed by a radar system (e.g., radar system 100). The number and angles of the beams may vary and may depend on the layout of the antennas used. In one example for automotive radar, elevation beams 210 include a set of scans at six angles (from a horizontal plane): -3°, 0°, 3°, 6°, 9°, and 12°. Other embodiments may use a different number of beings and/or different set of angles.

FIG. 2B is a simplified graph illustrating an example Tx antenna layout 230 (e.g., which may correspond to the layout of a Tx antenna in FIG. 1). In this example, the TX antenna layout 230 comprises two columns of 24 elements per column. Further, in this the illustrated embodiment, antennas are separated by 0.54 λ, and columns are separated by 8.8 λ. In an implementation, this may result in columns being separated by 3.35 cm, where total column length, L, is 4.9 cm. Moreover, in this example, a single digital-to-analog converter (DAC) may be used by the transceiver to support these antenna elements. Alternative embodiments may vary, having a different value for λ, a different number of elements per column (e.g., 16-32), different number of columns, different distances between antenna elements and/or columns, etc. depending on desired functionality.

FIG. 2C T is a simplified graph illustrating an example Rx antenna layout 240 (e.g., which may correspond to the layout of a Rx antenna in FIG. 1). Here, the Rx antenna layout 240 comprises a single row of antenna elements, where elements are spaced by approximately 0.55 λ, and overall row length is 8.8 λ. In this example, there are 16 antenna elements (in which case there may be 16 corresponding analog-to-digital converters (ADCs) in the transceiver to support these antenna elements. Again, alternative embodiments may utilize different layouts, which may comprise more than one row of antenna elements, a different number of antenna elements per row, different spacing/proportions, etc.

As noted, the number of elevation beams 210 may be limited due to various constraints (e.g., hardware and time constraints). However, beamspace processing algorithms performed on the radar data obtained from the radar scan can provide a higher resolution (as shown by super resolution granularity 250). As noted, although these algorithms traditionally require an additional step to map received RF signals to beamspace and may be utilized only to detect objects that are stationary, embodiments address these issues by performing analog beamforming with the Tx antennas and further taking into account radar (e.g., vehicle) speed. However, because embodiments utilize analog Tx beamforming to provide measurements at different elevation angles, and because vehicle speed can be taken into account to offset the relative motion of objects, received radar data can be treated as if beamspace mapping was done in super resolution techniques, allowing embodiments to use beamspace super resolution techniques to provide better radar.

An example technique for digitally processing a vector of measurements, y, received at the Rx antenna array using traditional a traditional algorithm (spectral MUSIC) comprises performing the following four operations:
1. Computing an estimate of the covariance, R = E[yy′], where E is the expectation;
2. Evaluating the eigenvectors of the covariance: U = SVD(R), where SVD(R) is the Singular Value Decomposition (SVD) of covariance estimate R;
3. Assuming n targets, the eignvectors corresponding to the lower eigenvalues can be taken, starting from the n +1 -th eigenvalue. Call these eigenvectors G; and
4. The pseudo spectrum can then be evaluated according to:
$$P = \frac{1}{{a}^{′} G {G}^{′} a} ,$$
where a is a vector called a tilting vector, which is a sample of complex exponential at a certain angular frequency. Each frequency has different tilting vector a, for which pseudo spectrum P can be evaluated.

Because of the complexity of this process, it may be difficult to evaluate the covariance matrix and SVD of a large number of samples (e.g., 32 samples) given time and processing constraints. However, constraints may allow for the processing of fewer samples (e.g., 8 samples) in beamspace. So, according to some embodiments, beamspace processing can be used instead.

According to some embodiments, to process vector y in beamspace, a process similar to the process above can be used in which y is replaced with y_{B} = B′y, where B is the mapping matrix. (In some embodiments, this may be a Fast Fourier Transform (FFT). But other transformations may be used.) The rest of the process can then be performed in the beam domain, for example, using the following operations:
1. For mapping 32 input samples to 8 samples in beamspace, B may be a 32 × 8 beamforming matrix at a chosen 8 sector angles;
2. Covariance is evaluated in beamspace: R_{B} = E[B′yy′B] = B′RB;
3. SVD of covariance in the beamspace is determined: U_{B} = SVD(R_{B});
4. Eigenvectors G_{B} are then taken (starting from the n +1 -th eigenvalue, assuming n targets); and
5. The pseudo spectrum can then be evaluated according to:
$${P}_{B} = \frac{1}{{b}^{′} G {G}^{′} b} ,$$
where b = B′a. (Here, the tilting vector b is the beamspace mapping of the tilting vector a.)

According to embodiments, because analog beamforming is used to provide elevation data, beamspace processing be used to provide super resolution of samples received at the Rx antenna array. Thus, analog beamforming both simplifies the hardware implementation of the Tx antenna chain and simplifies the digital processing of samples received at the Rx antenna array. This is because the received samples are already in beamspace; analog beamforming results in the mathematical equivalent of mapping samples to the beamspace. That is, analog beamforming results in the Rx antenna receiving vector y_{B} rather than vector y.

Because each elevation measurement is carried in a different time during a scan (e.g., in series, one after the other), objects moving relatively to the radar system may be at different distances for different elevation measurements. An object moving toward the radar, for example, will be closer to the radar at the end of a radar scan (e.g., during the last elevation measurement) than at the beginning of the radar scan (e.g., during the first elevation measurement). However, super-resolution algorithms assume measurements are taken at the same time. Thus, to allow super resolution algorithms to be performed on received data of a radar scan for a moving radar system (e.g., on a moving vehicle), phases of the received data can be altered to compensate for relative movement of a detected object, based on the known speed of the radar system.

It can be noted that embodiments are not limited to determining super resolution using the beamspace algorithm above. Super-resolution techniques can include any technique that can be used to improve the elevation resolution of a radar system beyond the native resolution. This can include, for example, existing beamspace processing techniques (root-MUSIC, ESPRIT, etc.) and/or future techniques. The techniques herein for providing elevation super resolution may be used with super resolution algorithms for other dimensions (azimuth, range, Doppler).

FIG. 3 is a series of graphs that illustrate how embodiments can provide elevation super resolution in a first example. In this example, two targets are located at different elevations relative to the radar system: 9.3° and 9.8°. As illustrated in a first graph 310 (a grayscale reproduction of an elevation speed map, where higher energy is represented by lighter shades of gray), the two objects have two different speeds: 1 m/s and 6 m/s. The second graph 320 illustrates how, at native resolution having elevation sectors at -6°, 0°, 3°, 6°, 9°, and 12°, both objects are detected at the 9° sector. Thus, without super resolution processing, the different elevations of the objects are indistinguishable. The third graph 330, however, illustrates the resulting super resolution provided by processing all input samples using a beamspace MUSIC algorithm, which results in two separate peaks showing objects at two different elevations.

FIG. 4 is a series of graphs similar to those in FIG. 3, which illustrate how embodiments can provide elevation super resolution in a second example. Similar to the first example in FIG. 3, this example includes two targets are located at different elevations relative to the radar system: 9.3° and 9.8°. In this example, however, the two targets have the same speed. Thus, they are indistinguishable in the elevation speed map of the first graph 410 (similar to graph 310 of FIG. 3, graph 410 is a grayscale reproduction of an elevation speed map, where higher energy is represented by lighter shades of gray). Again, both objects are detected at the 9° sector in native resolution, as shown in the second graph 420. Again, the third graph 430 illustrates the resulting super resolution provided by processing all input samples using a beamspace MUSIC algorithm, which again results in two separate peaks 440 showing objects to different elevations.

FIG. 5 is a graph 510 showing accuracy as a function of SNR, illustrating how a knowledge of the speed of the targets can affect accuracy. The set of plots 520 illustrate how accuracy improves with increased SNR where the speed of the objects is known and compensated for in the beamspace algorithm. The plot 530, on the other hand, illustrates how accuracy may not improve if the speed of objects is unknown. This is because, as previously noted, the mathematics behind beamspace algorithms often require that the target remains still while the scans are being performed so that the target will remain in the same speed (Doppler) bin. The graph 510 is an example of resolutions achievable using a super resolution algorithm on a radar system with a native elevation resolution of 3°. As can be seen, accuracy can be increased to a small fraction of a degree with enough SNR (which may happen in instances where objects have highly reflective surfaces).

Given this information, embodiments herein can be used to accurately detect stationary objects in an automotive application if the speed of the vehicle is known. That is, by receiving input from one or more speed sensors of the vehicle, the speed of stationary objects (relative to the vehicle) is known and can be used to alter incoming radar data (in the manner described above) to compensate for movement during a scan. This can enable a beamspace algorithm to be used to perform super resolution on the received samples, once adjusted.

FIG. 6 is a flow diagram of a method 600 of obtaining super resolution in a radar system, according to an embodiment. The super resolution may apply to one or more dimensions of radar data, including elevation and/or azimuth dimensions. Alternative embodiments may vary in function by combining, separating, or otherwise varying the functionality described in the blocks illustrated in FIG. 6. Means for performing the functionality of one or more of the blocks illustrated in FIG. 6 may comprise hardware and/or software components of a radar system, such as the radar system 100 illustrated in FIG. 1 and/or a computer system, such as the computer system 700 shown in FIG. 7 and described below.

At block 610, the functionality comprises performing a scan with the radar system, wherein the scan comprises performing the functions illustrated in block 610-a and 610-b. This includes, at block 610-a, transmitting, with the radar system, radar signals using a plurality of beams, wherein the plurality of elevation beams are created using analog beamforming. At block 610-b, the functionality includes receiving, with the radar system, reflected radar signal data from reflections of the radar signals off of one or more objects. Depending on desired functionality, the plurality of beams may comprise a plurality of elevation beams, a plurality of azimuth beams, or both. Radar signals can, for example, include chirp-sequence modulation pulses (e.g., frequency-modulated continuous-wave radar (FMCW)) or other signals capable of providing a radar image of objects within a scanned volume (a scanned field-of-view and range).

It can be noted that the techniques for achieving super resolution described herein can be achieved even if the transmission beams are predetermined and fixed. Thus, for or some embodiments of the method 600, each beam is transmitted in a respective direction (e.g., elevation and/or azimuth) that is predetermined and fixed. Additionally or alternatively, techniques also may be used in embodiments in which beams are relatively low resolution and/or few in number. Thus, for or some embodiments of the method 600, there are fewer than five beams. That said, other embodiments may have a larger or smaller number.

Means for performing the functionality at block 610 may comprise one or more components of a radar system, such as antenna(s) 102, transceiver 104, edge computing device 106 (including DSP 110, MCU 112, and/or interfaces 114), and/or other components of the radar system 100 of FIG. 1, as previously described, which can be integrated into a computer system (e.g., as illustrated in FIG. 7 and described below), and/or communicatively coupled with the vehicle computer (e.g., as illustrated in FIG. 1 and previously described).

At block 620, the functionality comprises determining a speed of the radar system while the scan was performed. As noted, for automotive applications where the radar system is located in or on a vehicle, this may comprise determining the speed of the vehicle using one or more speed sensors of the vehicle. Additionally or alternatively, determining the speed of the radar system may comprise obtaining data indicative of the speed of the radar system from another device, such as a computer or sensor (e.g., of a vehicle).

Means for performing the functionality at block 620 may comprise one or more components of a radar system, such as antenna(s) 102, transceiver 104, edge computing device 106 (including DSP 110, MCU 112, and/or interfaces 114), and/or other components of the radar system 100 of FIG. 1, as previously described, which can be integrated into a computer system (e.g., as illustrated in FIG. 7 and described below), and/or communicatively coupled with the vehicle computer (e.g., as illustrated in FIG. 1 and previously described).

At block 630, the functionality comprises offsetting the reflected radar signal data by the determined speed of the radar system. This offsetting of the reflected radar signal data (e.g., accounting for the determined speed to adjust the radar signal data as if elevation measurements are generated at the same time) can allow beamspace algorithms to be used on the reflected radar signal data to provide super resolution accuracy. Otherwise, as shown in FIG. 5, super resolution may not be achievable by these algorithms if speed is not taken into account.

Means for performing the functionality at block 630 may comprise one or more components of a radar system, such as antenna(s) 102, transceiver 104, edge computing device 106 (including DSP 110, MCU 112, and/or interfaces 114), and/or other components of the radar system 100 of FIG. 1, as previously described, which can be integrated into a computer system (e.g., as illustrated in FIG. 7 and described below), and/or communicatively coupled with the vehicle computer (e.g., as illustrated in FIG. 1 and previously described).

At block 640, the functionality comprises obtaining the super resolution by processing the offset reflected radar signal data using techniques from a beamspace super resolution estimation. As noted, the beamspace super resolution estimation may be obtained from a beamspace algorithm performed on the offset reflected radar signal data as if beamspace mapping was already performed. And thus, only the “post beam-map” aspects of the beamspace algorithm may be used. Different algorithms may be used to obtain the beamspace super resolution estimation in different embodiments, depending on desired functionality. In some embodiments, the beamspace estimation is obtained from beamspace MUSIC or beamspace ESPRIT algorithms.

Depending on desired functionality, the method 600 may include one or more additional functions. For example, according to some embodiments, an edge computing device of the radar system may perform the processing the offset reflected radar signal data using the beamspace estimation. In such embodiments, data indicative of the super resolution may be provided by the radar system to a computer communicatively coupled with the radar system. According to some embodiments, the computer may comprise a vehicle computer. Additionally or alternatively, determining the speed of the radar system may comprise obtaining, with the edge computing device, data indicative of the speed of the radar system from the computer or a sensor. Some embodiments of the method 600 may further comprise outputting a position of each of the one or more objects based on the super resolution. This may be output, for example, by the radar system to a separate device (e.g., a vehicle computer). According to some embodiments, each beam may be transmitted in a respective direction that is predetermined and fixed. Additionally or alternatively, according to some embodiments, the plurality of beams comprises fewer than five beams. Again, other embodiments may have five beams or more.

FIG. 7 is a block diagram of an embodiment of a computer system 700, which may be utilized as described in embodiments herein. For example, the computer system 700 may correspond to a vehicle computer 108, as illustrated in FIG. 1. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner. In addition, it can be noted that components illustrated by FIG. 7 can be localized to a single device and/or distributed among various networked devices, which may be disposed at different physical or geographical locations. For example, different components of the computer system 700 may be located at different locations on a vehicle.

The computer system 700 is shown comprising hardware elements that can be electrically coupled via a bus 705 (or may otherwise be in communication, as appropriate). The hardware elements may include processing unit(s) 710, which can include without limitation one or more general-purpose processors, one or more special-purpose processors (such as digital signal processing chips, graphics acceleration processors, and/or the like), and/or other processing structure, which can be configured to perform one or more of the methods described herein, including the method described in relation to FIG. 7. The computer system 700 also can include one or more input devices 715, which can include without limitation one or more user interfaces, automotive subsystems, sensors, and/or the like; and one or more output devices 720, which can include without limitation one or more user interfaces, automotive subsystems, and/or the like. In some embodiments, a radar system 100 may comprise an input device 715 of the computer system 700. In other embodiments, as illustrated in FIG. 7, the radar system 100 may comprise a separate component of the computer system 700.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 700 may also include a communications subsystem 730, which can include support of wireline communication technologies and/or wireless communication technologies (in some embodiments) managed and controlled by a wireless communication interface 733. The communications subsystem 730 may include a modem, a network card, an infrared communication device, a wireless communication device, and/or a chipset, and/or the like. The communications subsystem 730 may include one or more input and/or output communication interfaces, such as the wireless communication interface 733, to permit data and signaling to be exchanged with a network, mobile devices, other computer systems, and/or any other electronic devices described herein.

In many embodiments, the computer system 700 will further comprise a working memory 735, which can include a RAM and/or or ROM device. Software elements, shown as being located within the working memory 735, can include an operating system 740, device drivers, executable libraries, and/or other code, such as application(s) 745, which may comprise computer programs provided by various embodiments, and/or may be designed to implement methods, and/or configure systems, provided by other embodiments, as described herein. Merely by way of example, one or more procedures described with respect to the method(s) discussed above, such as the method described in relation to FIG. 7, may be implemented as code and/or instructions that are stored (e.g. temporarily) in working memory 735 and are executable by a computer (and/or a processing unit within a computer such as processing unit(s) 710); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 725 described above. In some cases, the storage medium might be incorporated within a computer system, such as computer system 700. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description, embodiments may include different combinations of features. Implementation examples are described in the following numbered clauses:

Clause 1. A method of obtaining super resolution in a radar system, the method comprising: performing a scan with the radar system, wherein the scan comprises: transmitting, with the radar system, radar signals using a plurality of beams, wherein the plurality of beams is created using analog beamforming; and receiving, with the radar system, reflected radar signal data, from reflections of the radar signals off of one or more objects; determining a speed of the radar system while the scan was performed; offsetting the reflected radar signal data by the determined speed of the radar system; and obtaining the super resolution by processing the offset reflected radar signal data using techniques from a beamspace super resolution estimation.

Clause 2. The method of clause 1, wherein the plurality of beams comprises a plurality of elevation beams, a plurality of azimuth beams, or both.

Clause 3. The method of any of clauses 1-2 wherein the beamspace super resolution estimation comprises beamspace MUSIC or beamspace ESPRIT.

Clause 4. The method of any of clauses 1-3 wherein the radar system is located in or on a vehicle, and wherein the speed of the radar system is determined using one or more speed sensors of the vehicle.

Clause 5. The method of any of clauses 1-4 wherein processing the offset reflected radar signal data using the beamspace super resolution estimation is performed by an edge computing device of the radar system; and data indicative of the super resolution is provided by the radar system to a computer communicatively coupled with the radar system.

Clause 6. The method of clause 5 wherein the computer comprises a vehicle computer.

Clause 7. The method of clause 5 wherein determining the speed of the radar system comprises obtaining, with the edge computing device, data indicative of the speed of the radar system from the computer or a sensor.

Clause 8. The method of any of clauses 1-7 further comprising outputting a position of each of the one or more objects based on the super resolution.

Clause 9. The method of any of clauses 1-8 wherein each beam is transmitted in a respective direction that is predetermined and fixed.

Clause 10. The method of any of clauses 1-9 wherein the plurality of beams comprises fewer than five beams.

Clause 11. A radar system for obtaining super resolution, the radar system comprising: one or more antennas; a transceiver; and one or more processors communicatively coupled with the one or more antennas and the transceiver, wherein the one or more processors are configured to: perform a scan with the radar system, wherein the scan comprises: transmitting, with the transceiver and the one or more antennas, radar signals using a plurality of beams, wherein the plurality of beams is created using analog beamforming; and receiving, with the transceiver and the one or more antennas, reflected radar signal data, from reflections of the radar signals off of one or more objects; determine a speed of the radar system while the scan was performed; offset the reflected radar signal data by the determined speed of the radar system; and obtain the super resolution by processing the offset reflected radar signal data using techniques from a beamspace super resolution estimation.

Clause 12. The radar system of clause 11, wherein, to create the plurality of beams, the radar system is configured to create a plurality of elevation beams, a plurality of azimuth beams, or both.

Clause 13. The radar system of any of clauses 11-12 wherein the one or more processors are configured to obtain the beamspace super resolution estimation by performing beamspace MUSIC or beamspace ESPRIT.

Clause 14. The radar system of any of clauses 11-13 wherein the one or more processors are configured to determine the speed of the radar system by receiving the speed of the radar system from one or more speed sensors of a vehicle.

Clause 15. The radar system of any of clauses 11-14 wherein the one or more processors are incorporated into an edge computing device configured to process the offset reflected radar signal data using the beamspace super resolution estimation; and the radar system is further configured to provide data indicative of the super resolution to a computer communicatively coupled with the radar system.

Clause 16. The radar system of clause 15 wherein the computer comprises a vehicle computer.

Clause 17. The radar system of clause 15 wherein, to determine the speed of the radar system, the edge computing device is configured to obtain data indicative of the speed of the radar system from the computer or a sensor.

Clause 18. The radar system of any of clauses 11-17 wherein the one or more processors are further configured to output a position of each of the one or more objects based on the super resolution.

Clause 19. The radar system of any of clauses 11-18 wherein the radar system is configured to create the plurality of beams such that each beam is transmitted in a respective direction that is predetermined and fixed.

Clause 20. The radar system of any of clauses 11-19 wherein the radar system is configured to create the plurality of beams such that the plurality of beams comprises fewer than five beams.

Clause 21. An apparatus for obtaining super resolution in a radar system, the apparatus comprising: means for performing a scan with the radar system, wherein the means for performing the scan comprises: means for transmitting radar signals using a plurality of beams, wherein the plurality of beams is created using analog beamforming; and means for receiving reflected radar signal data, from reflections of the radar signals off of one or more objects; means for determining a speed of the radar system while the scan was performed; means for offsetting the reflected radar signal data by the determined speed of the radar system; and means for obtaining the super resolution by processing the offset reflected radar signal data using techniques from a beamspace super resolution estimation.

Clause 22. The apparatus of clause 21, wherein the means for transmitting the radar signals are configured to create the plurality of beams such that the plurality of beams comprises a plurality of elevation beams, a plurality of azimuth beams, or both.

Clause 23. The apparatus of any of clauses 21-22 wherein means for obtaining the super resolution comprises means for performing beamspace MUSIC or beamspace ESPRIT.

Clause 24. The apparatus of any of clauses 21-23 wherein the means for determining the speed of the radar system comprises means for obtaining the speed of the radar system from one or more speed sensors of a vehicle.

Clause 25. The apparatus of any of clauses 21-24 further comprising means for outputting a position of each of the one or more objects based on the super resolution.

Clause 26. The apparatus of any of clauses 21-25 wherein the means for transmitting the radar signals are configured to create the plurality of beams such that each beam is transmitted in a respective direction that is predetermined and fixed.

Clause 27. The apparatus of any of clauses 21-26 wherein the means for transmitting the radar signals are configured to create the plurality of beams such that the plurality of beams comprises fewer than five beams.

Clause 28. A non-transitory computer-readable medium storing instructions for obtaining super resolution in a radar system, the instructions comprising code for: performing a scan with the radar system, wherein the scan comprises: transmitting radar signals using a plurality of beams, wherein the plurality of beams are created using analog beamforming; and receiving reflected radar signal data, from reflections of the radar signals off of one or more objects; determining a speed of the radar system while the scan was performed; offsetting the reflected radar signal data by the determined speed of the radar system; and obtaining the super resolution by processing the offset reflected radar signal data using techniques from a beamspace super resolution estimation.

Clause 29. The computer-readable medium of clause 28, wherein the code for obtaining the super resolution comprises code for performing beamspace MUSIC or beamspace ESPRIT.

Clause 30. The computer-readable medium of any of clauses 28-29 wherein the code for determining the speed of the radar system comprises code for obtaining the speed of the radar system using one or more speed sensors of a vehicle.

What is claimed is:

1. A method of obtaining super resolution in a radar system, the method comprising:
performing a scan with the radar system, wherein the scan comprises:
transmitting, with the radar system, radar signals using a plurality of beams, wherein the plurality of beams is created using analog beamforming; and
receiving, with the radar system, reflected radar signal data, from reflections of the radar signals off of one or more objects;
determining a speed of the radar system while the scan was performed;
offsetting the reflected radar signal data by the determined speed of the radar system; and
obtaining the super resolution by processing the offset reflected radar signal data using techniques from a beamspace super resolution estimation.

2. The method of claim 1, wherein the plurality of beams comprises a plurality of elevation beams, a plurality of azimuth beams, or both.

3. The method of claim 1, wherein the beamspace super resolution estimation comprises beamspace MUSIC or beamspace ESPRIT.

4. The method of claim 1, wherein the radar system is located in or on a vehicle, and wherein the speed of the radar system is determined using one or more speed sensors of the vehicle.

5. The method of claim 1, wherein:
processing the offset reflected radar signal data using the beamspace super resolution estimation is performed by an edge computing device of the radar system; and
data indicative of the super resolution is provided by the radar system to a computer communicatively coupled with the radar system.

6. The method of claim 5, wherein the computer comprises a vehicle computer.

7. The method of claim 5, wherein determining the speed of the radar system comprises obtaining, with the edge computing device, data indicative of the speed of the radar system from the computer or a sensor.

8. The method of claim 1, further comprising outputting a position of each of the one or more objects based on the super resolution.

9. The method of claim 1, wherein each beam is transmitted in a respective direction that is predetermined and fixed.

10. The method of claim 1, wherein the plurality of beams comprises fewer than five beams.

11. A radar system for obtaining super resolution, the radar system comprising:
one or more antennas;
a transceiver; and
one or more processors communicatively coupled with the one or more antennas and the transceiver, wherein the one or more processors are configured to:
perform a scan with the radar system, wherein the scan comprises:
transmitting, with the transceiver and the one or more antennas, radar signals using a plurality of beams, wherein the plurality of beams is created using analog beamforming; and
receiving, with the transceiver and the one or more antennas, reflected radar signal data, from reflections of the radar signals off of one or more objects;
determine a speed of the radar system while the scan was performed;
offset the reflected radar signal data by the determined speed of the radar system; and
obtain the super resolution by processing the offset reflected radar signal data using techniques from a beamspace super resolution estimation.

12. The radar system of claim 11, wherein, to create the plurality of beams, the radar system is configured to create a plurality of elevation beams, a plurality of azimuth beams, or both.

13. The radar system of claim 11, wherein the one or more processors are configured to obtain the beamspace super resolution estimation by performing beamspace MUSIC or beamspace ESPRIT.

14. The radar system of claim 11, wherein the one or more processors are configured to determine the speed of the radar system by receiving the speed of the radar system from one or more speed sensors of a vehicle.

15. The radar system of claim 11, wherein the one or more processors are incorporated into an edge computing device configured to process the offset reflected radar signal data using the beamspace super resolution estimation; and
the radar system is further configured to provide data indicative of the super resolution to a computer communicatively coupled with the radar system.

16. The radar system of claim 15, wherein the computer comprises a vehicle computer.

17. The radar system of claim 15, wherein, to determine the speed of the radar system, the edge computing device is configured to obtain data indicative of the speed of the radar system from the computer or a sensor.

18. The radar system of claim 11, wherein the one or more processors are further configured to output a position of each of the one or more objects based on the super resolution.

19. The radar system of claim 11, wherein the radar system is configured to create the plurality of beams such that each beam is transmitted in a respective direction that is predetermined and fixed.

20. The radar system of claim 11, wherein the radar system is configured to create the plurality of beams such that the plurality of beams comprises fewer than five beams.

21. An apparatus for obtaining super resolution in a radar system, the apparatus comprising:
means for performing a scan with the radar system, wherein the means for performing the scan comprises:
means for transmitting radar signals using a plurality of beams, wherein the plurality of beams is created using analog beamforming; and
means for receiving reflected radar signal data, from reflections of the radar signals off of one or more objects;
means for determining a speed of the radar system while the scan was performed;
means for offsetting the reflected radar signal data by the determined speed of the radar system; and
means for obtaining the super resolution by processing the offset reflected radar signal data using techniques from a beamspace super resolution estimation.

22. The apparatus of claim 21, wherein the means for transmitting the radar signals are configured to create the plurality of beams such that the plurality of beams comprises a plurality of elevation beams, a plurality of azimuth beams, or both.

23. The apparatus of claim 21, wherein means for obtaining the super resolution comprises means for performing beamspace MUSIC or beamspace ESPRIT.

24. The apparatus of claim 21, wherein the means for determining the speed of the radar system comprises means for obtaining the speed of the radar system from one or more speed sensors of a vehicle.

25. The apparatus of claim 21, further comprising means for outputting a position of each of the one or more objects based on the super resolution.

26. The apparatus of claim 21, wherein the means for transmitting the radar signals are configured to create the plurality of beams such that each beam is transmitted in a respective direction that is predetermined and fixed.

27. The apparatus of claim 21, wherein the means for transmitting the radar signals are configured to create the plurality of beams such that the plurality of beams comprises fewer than five beams.

28. A non-transitory computer-readable medium storing instructions for obtaining super resolution in a radar system, the instructions comprising code for:
performing a scan with the radar system, wherein the scan comprises:
transmitting radar signals using a plurality of beams, wherein the plurality of beams are created using analog beamforming; and
receiving reflected radar signal data, from reflections of the radar signals off of one or more objects;
determining a speed of the radar system while the scan was performed;
offsetting the reflected radar signal data by the determined speed of the radar system; and
obtaining the super resolution by processing the offset reflected radar signal data using techniques from a beamspace super resolution estimation.

29. The computer-readable medium of claim 28, wherein the code for obtaining the super resolution comprises code for performing beamspace MUSIC or beamspace ESPRIT.

30. The computer-readable medium of claim 28, wherein the code for determining the speed of the radar system comprises code for obtaining the speed of the radar system using one or more speed sensors of a vehicle.
